(19) United States
(12) Patent Application Publication
(10) Pub. No.: US 2026/0349178 A1
(43) Pub. Date: Nov. 5, 2026

(54) PHOTONICS WAVEGUIDE RESONATOR WITH INCREASED LOSS FOR HIGHER-ORDER MODES

(71) Applicant: Honeywell International Inc., Charlotte, NC (US)

(72) Inventors: Matthew Wade Puckett, Phoenix, AZ (US); Jianfeng Wu, Tucson, AZ (US); Chad Hoyt, Roseville, MN (US); Karl D. Nelson, Plymouth, MN (US)

(73) Assignee: Honeywell International Inc., Charlotte, NC (US)

(21) Appl. No.: 19/197,469

(22) Filed: May 2, 2025

(51) Int. Cl. G02B 6/293

(52) U.S. Cl. CPC G02B 6/29338

(57) ABSTRACT

A device comprises a waveguide platform, an optical resonator in the waveguide platform, and a wedge-shaped structure in the waveguide platform and in proximity to the optical resonator. The wedge-shaped structure includes a first tapered portion that increases in width along a first distance, and a second tapered portion that decreases in width along a second distance that is shorter than the first distance. As light propagates in the optical resonator in a direction toward the first portion of the wedge-shaped structure, at least a portion of higher-order modes of the light are routed out of the optical resonator, while a fundamental mode of the light is maintained in the optical resonator.

### STATEMENT REGARDING FEDERALLY SPONSORED RESEARCH OR DEVELOPMENT

This invention was made with Government support under HR0011-22-C-0018 awarded by DARPA. The Government has certain rights in the invention.

### BACKGROUND

Stimulated Brillouin scattering (SBS) lasers are a valuable class of technology, producing light with extremely narrow linewidths. In the state-of-the-art, these lasers are made in integrated photonics platforms by designing optical resonators in which the free-spectral range (FSR) matches the frequency shift corresponding to Brillouin scattering. In general, the performance of such a laser scales favorably as the loss coefficient of the constituent waveguide is reduced.

One of the most effective ways to reduce waveguide loss is by increasing a width of the waveguide, thereby reducing the overlap of the optical mode with rough sidewalls of the waveguide. However, this approach also results in the waveguide supporting multiple transverse modes, which can compromise the performance of the laser.

### SUMMARY

A device comprises a waveguide platform, an optical resonator in the waveguide platform, and a wedge-shaped structure in the waveguide platform and in proximity to the optical resonator. The wedge-shaped structure includes a first tapered portion that increases in width along a first distance, and a second tapered portion that decreases in width along a second distance that is shorter than the first distance. As light propagates in the optical resonator in a direction toward the first portion of the wedge-shaped structure, at least a portion of higher-order modes of the light are routed out of the optical resonator, while a fundamental mode of the light is maintained in the optical resonator.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is top down schematic view of a photonics waveguide device with a microdisk resonator, which provides increased loss for higher-order modes of light, according to one embodiment;

FIG. 2 is top down conformal mapping view of a waveguide device with a microdisk resonator, which provides increased loss for higher-order modes of light, according to one embodiment;

FIGS. 3A and 3B are graphs of a simulated performance of a waveguide device, such as the waveguide device of FIG. 2; and

FIG. 4 is a block diagram of an SBS laser system, which utilizes a waveguide device with a microdisk resonator to provide increased loss for higher-order modes of light, according to an example embodiment.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

Embodiments of a photonics waveguide resonator device that provide increased loss for higher-order modes of light, are described herein. In various embodiments, the waveguide resonator device is able to selectively increase loss for higher-order modes in a laser system, such as for stimulated Brillouin scattering (SBS) laser, while preserving low loss for the fundamental mode of the SBS laser.

The present waveguide resonator device improves the performance of lasers such as SBS lasers by maintaining low loss of a multimode waveguide while deliberately increasing loss of the higher-order modes, preventing the higher-order modes from interfering with laser operation. This performance improvement is achieved by including a narrow, tapered wedge structure of waveguide material beside an optical resonator such as a microdisk resonator on a waveguide platform. As the wedge structure widens, the higher-order modes are extracted from the resonator, and as the wedge structure narrows, a fraction of the power coupled into the wedge structure is ejected out of the waveguide material. This results in significant loss for the higher-order modes. However, the fundamental mode does not couple into the wedge structure, and thus low loss of the fundamental mode is preserved.

The present technique can result in the effective use of ultra-low loss multimode waveguides in the design of SBS lasers, enabling increased output power and reduced linewidth. To operate such a laser, optical pump power is injected into a bus waveguide that is adjacent to the optical resonator described herein. The optical pump power can either be scanned through an optical resonance or locked to a resonance of the resonator. When the pump power is at a sufficiently high optical power, the resonator will produce narrow linewidth laser light through SBS.

The waveguide resonator device with the tapered wedge structure can be fabricated in a waveguide platform that possesses a sufficiently large SBS gain coefficient and sufficiently low loss.

In one embodiment, a tapered, curved wedge structure is introduced in proximity to a microdisk resonator on a waveguide platform. As the wedge taper width increases, higher-order modes of light are routed out of the microdisk resonator. The wedge taper also reverses and decreases in width, where some higher-order light passes back into the microdisk resonator. This is done to maintain low loss for the fundamental mode, but it also reduces loss for the higher-order modes. If the tapering is conducted over a sufficient length, the light in the higher-order modes will have increased loss, whereas the light in the fundamental mode will not.

Further details of various embodiments are described hereafter and with reference to the drawings.

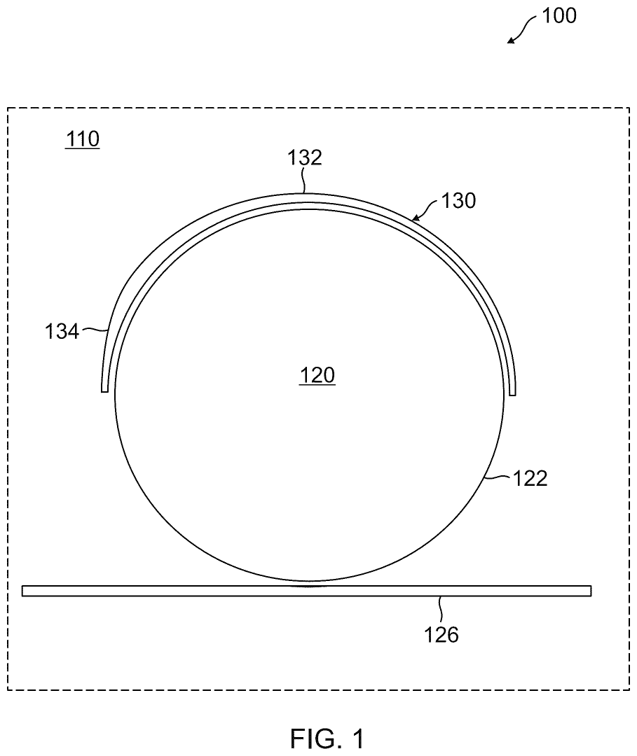

FIG. 1 illustrates a photonics waveguide device 100, according to one embodiment. The photonics waveguide device 100 includes a waveguide platform 110, such as an integrated photonics chip, and an optical resonator 120 formed on the waveguide platform 110. The optical resonator 120 can be a solid component comprising a microdisk resonator, a microtoroid resonator, or the like. The optical resonator 120 has a curved perimeter 122. A bus waveguide 126, formed on the waveguide platform 110, is optically coupled to the optical resonator 120. The bus waveguide 126 is configured to optically couple light into the optical resonator 120 from a light source.

A wedge-shaped structure 130 is formed on the waveguide platform 110 and is in proximity to the optical resonator 120. The wedge-shaped structure 130 has a curved shape that radially extends around a portion of the curved perimeter 122 of the optical resonator 120. The wedge-shaped structure 130 includes a first tapered portion 132 that gradually increases in width along a first distance, and a second tapered portion 134 that abruptly decreases in width along a second distance that is shorter than the first distance.

There are various parameters that can be defined for the relationship between the wedge-shaped structure 130 and the optical resonator 120. For example, the wedge-shaped structure 130 can be separated from the curved perimeter 122 of the optical resonator 120 by a distance of about 100 nm to about 2 μm. The wedge-shaped structure 130 can have a radius of curvature of about 10 μm to about 10 mm.

In one embodiment, the wedge-shaped structure 130 can reside on the same vertical layer as the optical resonator 120 such that they are co-planar. In another embodiment, the wedge-shaped structure 130 can reside on a separate vertical layer from the optical resonator 120.

When light is directed into the bus waveguide 126, a portion of the light is optically coupled into the optical resonator 120 in a counterclockwise direction from the bus waveguide 126, which excites multiple counterclockwise resonator modes. The coupled light propagates in the optical resonator 120 in a direction toward the first tapered portion 132 of the wedge-shaped structure 130. As described further hereafter, at least a portion of higher-order modes of the coupled light is routed out of the optical resonator 120 as the coupled light moves past the second tapered portion 134 of the wedge-shaped structure 130, while a fundamental mode of the light is maintained in the optical resonator 120. The fundamental mode of the light has a loss that is lower than a loss of the higher-order modes.

As the wedge-shaped structure 130 gradually widens as the light propagates, the higher-order modes gradually get pulled out of the optical resonator 120. The abrupt narrowing of the wedge-shaped structure 130 is too rapid for the higher-order modes to transition back into the optical resonator 120, so the higher-order modes radiate into free space.

The optical resonator 120 and the wedge-shaped structure 130 can be composed of various higher refractive index materials, such as silicon, silicon nitride (SiNx), silicon oxynitride (SiON), silicon carbide (SiC), diamond, silicon germanium (SiGe), germanium, gallium arsenide (GaAs), gallium nitride (GaN), gallium phosphide (GaP), lithium niobate (LiNbO₃), or combinations thereof. Moreover, the optical resonator 120 and the wedge-shaped structure 130 can be composed of the same material, or can be composed of different materials.

Various conventional processes may be employed to form the components of the photonics waveguide device 100, such as plasma-enhanced chemical vapor deposition (PECVD), high-density-plasma chemical vapor deposition (HDPCVD), low-pressure chemical vapor deposition (LPCVD), sputtering, atomic layer deposition, or the like.

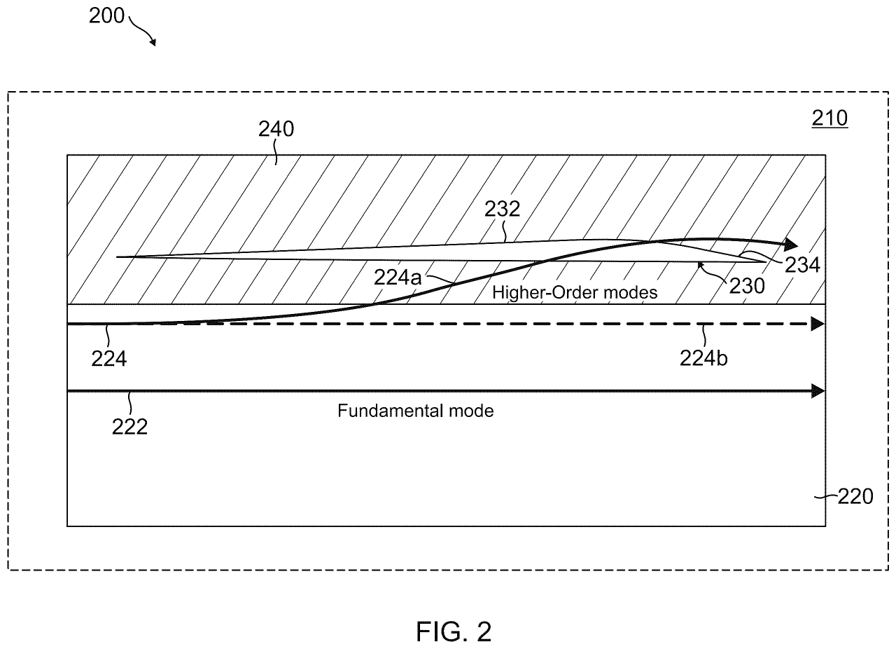

FIG. 2 illustrates a waveguide device 200 depicted using conformal mapping, according to an example embodiment. The waveguide device 200 includes a waveguide platform 210, and an optical resonator 220 formed on the waveguide platform 210. A wedge-shaped structure 230 is formed on the waveguide platform 210 and is in proximity to the optical resonator 220. The wedge-shaped structure 230 includes a first tapered portion 232 that gradually increases in width along a first distance, and a second tapered portion 234 that abruptly decreases in width along a second distance that is shorter than the first distance. A cladding layer 240 is formed on the waveguide platform 210, such that the optical resonator 220 and the wedge-shaped structure 230 are embedded om the cladding layer 240.

Although shown in a conformal configuration, the optical resonator 120 is a solid circular component such as a microdisk resonator, a microtoroid resonator, or the like, and the wedge-shaped structure 230 has a curved shape that radially extends around a portion of a curved perimeter of the optical resonator 220.

As shown in FIG. 2, light that is coupled into the optical resonator 220 includes a fundamental mode 222 and higher-order modes 224. The coupled light propagates in the optical resonator 220 in a direction toward the first tapered portion 232 of the wedge-shaped structure 230. As the width of the first tapered portion 232 gradually increases, a first portion 224a of the higher-order modes 224 is routed out of the optical resonator 220, while the fundamental mode 222 is maintained in the optical resonator 220. As the light moves past the second tapered portion 234, a second portion 224b of the higher-order modes passes back into the optical resonator 220.

The configuration of the wedge-shaped structure 230 with respect to the optical resonator 220 maintains low loss for the fundamental mode 222. If the tapering of the wedge-shaped structure 230 is over a sufficient length, such as about 1 mm or greater, the light in the higher-order modes 224 will have increased loss, whereas the light in the fundamental mode 222 will not.

The optical resonator 220 and the wedge-shaped structure 230 can be composed of various higher index materials, such as those described previously for the optical resonator 120 (FIG. 1). The cladding layer 240 can be composed of various lower index materials, such as silicon oxynitride, silicon dioxide (SiO₂), silicon nitride, germanium oxide (GeO₂), zinc oxide (ZnO), aluminum oxide (Al₂O₃), titanium dioxide (TiO2), magnesium oxide (MgO), or combinations thereof.

As shown in FIG. 2, the left end of the wedge-shaped structure 230 is very narrow, which minimally perturbs the modes. As the first tapered portion 232 gradually widens, the electric field intensity of the higher-order modes, which have a lower effective refractive index than the fundamental mode, gets redistributed such that the majority of energy of the higher-order modes resides in the wedge-shaped structure 230 instead of the optical resonator 220. As the second tapered portion 234 narrows abruptly, the higher-order modes are ejected from the wedge-shaped structure 230 into the cladding layer 240. This increases the loss for the higher-order modes, while the resonances corresponding to the fundamental mode are unaffected. The fundamental mode is not affected by the wedge-shaped structure 230 because it is located far enough away from the optical resonator 220, and the higher-order modes extend radially farther away from the optical resonator 220 than the fundamental mode.

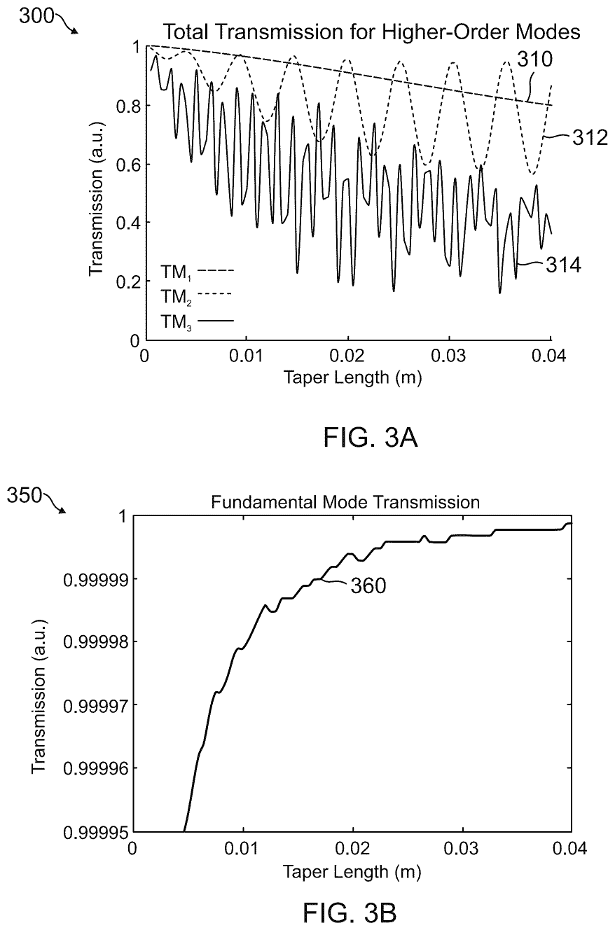

FIGS. 3A and 3B are graphs illustrating the simulated performance of a waveguide device configured according to the present approach, such as the waveguide device 200. FIG. 3A shows a graph 300 of the total transmission for higher-order modes of light, including the first three transverse magnetic (TM) modes (TM₁, TM₂, TM₃), with respect to taper length of a wedge-shaped structure in the waveguide device, such as the wedge-shaped structure 230. FIG. 3B shows a graph 350 of the fundamental mode transmission of light, with respect to taper length of the wedge-shaped structure.

The graph 300 of FIG. 3A shows a plot line 310 for the TM₁ mode, a plot line 312 for the TM₂ mode, and a plot line 314 for the TM₃ mode. The graph 300 demonstrates a downward trend in the transmitted power versus the taper length for each of the higher-order modes. As shown, the higher-order modes TM₂ and TM₃ have a periodicity with a higher spatial frequency. For the TM₂ mode, at a maximum of the transmission peaks of the periodic curve of the plot line 312, most of the power is transmitted through the waveguide device at the corresponding specific taper lengths. Thus, using a taper length where a minimum of the periodic curve of the plot line 312 lies is desirable. Nevertheless, a range of taper lengths can be selectively used to increase the loss for the three higher-order modes to varying extents such that their resonances effectively vanish from the optical resonator of the waveguide device.

The graph 350 of FIG. 3B shows a plot line 360 for the fundamental mode. The plot line 360 indicates that the fundamental mode has extremely high transmission regardless of the taper length value. As shown, the transmission monotonically increases as the taper gets longer.

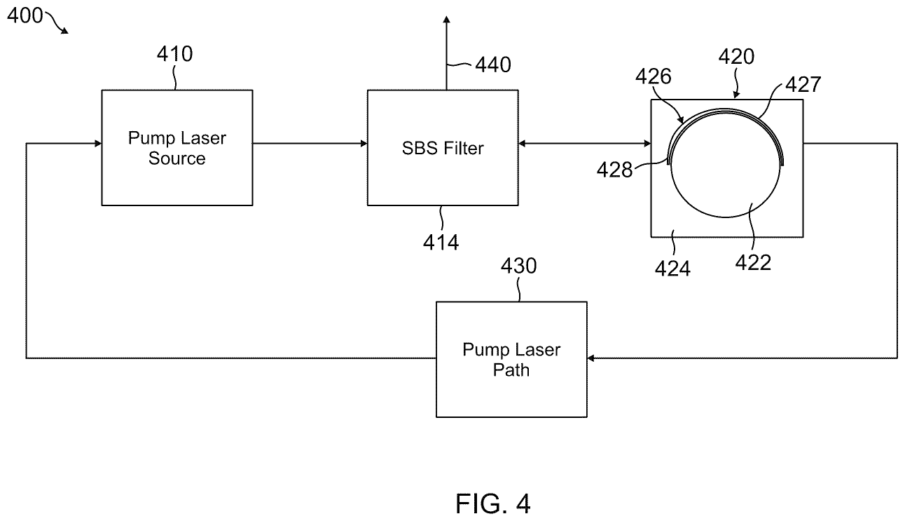

FIG. 4 is a block diagram of an SBS laser system 400 according to an example embodiment, which can utilize the present approach for providing increased loss for higher-order modes of laser light. The system 400 includes a pump laser source 410 that is optically coupled to an SBS filter 414, and an optical resonator 420 that is in optical communication with the SBS filter 414. A pump laser path 430 is configured to route a feedback signal from the optical resonator 420 to an input of the pump laser source 410. The pump laser path 430 can include optical fibers, waveguides, mirrors that reflect light through free space, or other optical transmission media.

As the resonant frequency of the pump laser source 410 is near a resonant frequency of the optical resonator 420, the feedback signal from the optical resonator 420 causes the frequency of the pump laser source 410 to lock to the resonance frequency of the optical resonator 420 due to effects of injection locking. The use of injection locking of the pump laser source 410 allows the components within the system 400 to be fabricated within a single integrated photonics chip in some implementations.

During operation, pump light emitted from the pump laser source 410 is directed through the SBS filter 414 and coupled into the optical resonator 420. The pump light propagates in a one direction within the optical resonator 420, which produces SBS laser light that propagates in an opposite direction due to stimulated Brillouin scattering. The SBS laser light is coupled back into the SBS filter 414, which couples the SBS light to a drop port of the SBS filter 414. The drop port transmits the SBS laser light to an SBS output 440, which provides the SBS laser light to other devices coupled to the system 400 or to other external components.

As shown, the optical resonator 420 can be a microdisk resonator 422 that is formed on a waveguide platform 424. A wedge-shaped structure 426 is formed on the waveguide platform 424 adjacent to the microdisk resonator 422. The wedge-shaped structure 426 has a curved shape that radially extends around a portion of the microdisk resonator 422. The wedge-shaped structure 426 includes a first tapered portion 427 that gradually increases in width along a first distance, and a second tapered portion 428 that abruptly decreases in width along a second distance that is shorter than the first distance.

When light is optically coupled into the microdisk resonator 422, the coupled light propagates in a direction toward the first tapered portion 427 of the wedge-shaped structure 426. At least a portion of higher-order modes of the light is routed out of the microdisk resonator 422 as the light moves past the second tapered portion 428, while a fundamental mode of the light is maintained in the microdisk resonator 422.

Additional example embodiments of SBS lasers that can utilize the present approach for providing increased loss for higher-order modes are described in U.S. Pat. No. 11,362,480, titled SELF-INJECTION LOCKED STIMULATED BRILLOUIN SCATTERING LASER, the disclosure of which is hereby incorporated by reference.

The present technique for providing increased loss for higher-order modes can be applied to various non-linear processes that are enhanced by using resonators, such as for a frequency reference. Examples of such non-linear processes include frequency comb generation, four-wave mixing, sum and difference frequency generation, second harmonic generation, spontaneous parametric down conversion, or the like.

### Example Embodiments

Example 1 includes a device comprising: a waveguide platform; an optical resonator in the waveguide platform; and a wedge-shaped structure in the waveguide platform and in proximity to the optical resonator, the wedge-shaped structure including a first tapered portion that increases in width along a first distance, and a second tapered portion that decreases in width along a second distance that is shorter than the first distance; wherein as light propagates in the optical resonator in a direction toward the first portion of the wedge-shaped structure, at least a portion of higher-order modes of the light are routed out of the optical resonator, while a fundamental mode of the light is maintained in the optical resonator.
Example 2 includes the device of Example 1, wherein the optical resonator has a curved perimeter, and the wedge-shaped structure has a curved shape that radially extends around a portion of the curved perimeter of the optical resonator.
Example 3 includes the device of any of Examples 1-2, wherein the optical resonator comprises a microdisk resonator, or a microtoroid resonator.
Example 4 includes the device of any of Examples 1-3, further comprising a bus waveguide in the waveguide platform, the bus waveguide configured to optically couple the light into the optical resonator from a light source.
Example 5 includes the device of Example 4, wherein the light is optically coupled into the optical resonator in a counterclockwise direction from the bus waveguide, which excites multiple counterclockwise resonator modes.
Example 6 includes the device of any of Examples 1-5, wherein as the light propagates in the optical resonator, the fundamental mode of the light has a loss that is lower than a loss of the higher-order modes.
Example 7 includes the device of any of Examples 1-6, wherein the wedge-shaped structure and the optical resonator are composed of same higher refractive index materials.
Example 8 includes the device of any of Examples 1-6, wherein the wedge-shaped structure and the optical resonator are composed of different higher refractive index materials.
Example 9 includes the device of any of Examples 1-8, wherein the wedge-shaped structure comprises silicon, silicon nitride, silicon oxynitride, silicon carbide, diamond, silicon germanium, germanium, gallium arsenide, gallium nitride, gallium phosphide, lithium niobate, or combinations thereof.
Example 10 includes the device of any of Examples 1-9, wherein the optical resonator comprises silicon, silicon nitride, silicon oxynitride, silicon carbide, diamond, silicon germanium, germanium, gallium arsenide, gallium nitride, gallium phosphide, lithium niobate, or combinations thereof.
Example 11 includes the device of any of Examples 1-10, further comprising a cladding layer in the waveguide platform, wherein the optical resonator and the wedge-shaped structure are embedded in the cladding layer.
Example 12 includes the device of Example 11, wherein the cladding layer comprises silicon oxynitride, silicon dioxide, silicon nitride, germanium oxide, zinc oxide, aluminum oxide, titanium dioxide, magnesium oxide, or combinations thereof.
Example 13 includes the device of any of Examples 1-12, wherein: the wedge-shaped structure is separated from the optical resonator by a distance of about 100 nm to about 2 μm; and the wedge-shaped structure has a radius of curvature of about 10 μm to about 10 mm.
Example 14 includes the device of any of Examples 1-13, wherein the waveguide platform is on an integrated photonics chip.
Example 15 includes a laser system comprising: a pump laser source configured to emit pump light; an optical resonator on a waveguide platform and in optical communication with the pump laser source; and a wedge-shaped structure on the waveguide platform and in proximity to the optical resonator, the wedge-shaped structure including a first tapered portion that increases in width along a first distance, and a second tapered portion that decreases in width along a second distance that is shorter than the first distance; wherein as the pump light propagates in the optical resonator in a direction toward the first portion of the wedge-shaped structure, at least a portion of higher-order modes of the pump light are routed out of the optical resonator, while a fundamental mode of the pump light is maintained in the optical resonator.
Example 16 includes the laser system of Example 15, wherein the optical resonator has a curved perimeter, and the wedge-shaped structure has a curved shape that radially extends around a portion of the curved perimeter of the optical resonator.
Example 17 includes the laser system of Example 16, wherein the optical resonator comprises a microdisk resonator, or a microtoroid resonator.
Example 18 includes the laser system of any of Examples 15-17, wherein a frequency of the pump laser source is locked to a resonance frequency of the optical resonator due to effects of injection locking.
Example 19 includes the laser system of any of Examples 15-18, wherein the laser system is configured as a stimulated Brillouin scattering (SBS) laser system.
Example 20 includes the laser system of any of Examples 15-19, wherein the laser system on an integrated photonics chip.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A device comprising:
a waveguide platform;
an optical resonator in the waveguide platform; and
a wedge-shaped structure in the waveguide platform and in proximity to the optical resonator, the wedge-shaped structure including a first tapered portion that increases in width along a first distance, and a second tapered portion that decreases in width along a second distance that is shorter than the first distance;
wherein as light propagates in the optical resonator in a direction toward the first portion of the wedge-shaped structure, at least a portion of higher-order modes of the light are routed out of the optical resonator, while a fundamental mode of the light is maintained in the optical resonator.

2. The device of claim 1, wherein the optical resonator has a curved perimeter, and the wedge-shaped structure has a curved shape that radially extends around a portion of the curved perimeter of the optical resonator.

3. The device of claim 1, wherein the optical resonator comprises a microdisk resonator, or a microtoroid resonator.

4. The device of claim 1, further comprising a bus waveguide in the waveguide platform, the bus waveguide configured to optically couple the light into the optical resonator from a light source.

5. The device of claim 4, wherein the light is optically coupled into the optical resonator in a counterclockwise direction from the bus waveguide, which excites multiple counterclockwise resonator modes.

6. The device of claim 1, wherein as the light propagates in the optical resonator, the fundamental mode of the light has a loss that is lower than a loss of the higher-order modes.

7. The device of claim 1, wherein the wedge-shaped structure and the optical resonator are composed of same higher refractive index materials.

8. The device of claim 1, wherein the wedge-shaped structure and the optical resonator are composed of different higher refractive index materials.

9. The device of claim 1, wherein the wedge-shaped structure comprises silicon, silicon nitride, silicon oxynitride, silicon carbide, diamond, silicon germanium, germanium, gallium arsenide, gallium nitride, gallium phosphide, lithium niobate, or combinations thereof.

10. The device of claim 1, wherein the optical resonator comprises silicon, silicon nitride, silicon oxynitride, silicon carbide, diamond, silicon germanium, germanium, gallium arsenide, gallium nitride, gallium phosphide, lithium niobate, or combinations thereof.

11. The device of claim 1, further comprising a cladding layer in the waveguide platform, wherein the optical resonator and the wedge-shaped structure are embedded in the cladding layer.

12. The device of claim 11, wherein the cladding layer comprises silicon oxynitride, silicon dioxide, silicon nitride, germanium oxide, zinc oxide, aluminum oxide, titanium dioxide, magnesium oxide, or combinations thereof.

13. The device of claim 1, wherein:
the wedge-shaped structure is separated from the optical resonator by a distance of about 100 nm to about 2 μm; and
the wedge-shaped structure has a radius of curvature of about 10 μm to about 10 mm.

14. The device of claim 1, wherein the waveguide platform is on an integrated photonics chip.

15. A laser system comprising:
a pump laser source configured to emit pump light;
an optical resonator on a waveguide platform and in optical communication with the pump laser source; and
a wedge-shaped structure on the waveguide platform and in proximity to the optical resonator, the wedge-shaped structure including a first tapered portion that increases in width along a first distance, and a second tapered portion that decreases in width along a second distance that is shorter than the first distance;
wherein as the pump light propagates in the optical resonator in a direction toward the first portion of the wedge-shaped structure, at least a portion of higher-order modes of the pump light are routed out of the optical resonator, while a fundamental mode of the pump light is maintained in the optical resonator.

16. The laser system of claim 15, wherein the optical resonator has a curved perimeter, and the wedge-shaped structure has a curved shape that radially extends around a portion of the curved perimeter of the optical resonator.

17. The laser system of claim 16, wherein the optical resonator comprises a microdisk resonator, or a microtoroid resonator.

18. The laser system of claim 15, wherein a frequency of the pump laser source is locked to a resonance frequency of the optical resonator due to effects of injection locking.

19. The laser system of claim 15, wherein the laser system is configured as a stimulated Brillouin scattering (SBS) laser system.

20. The laser system of claim 15, wherein the laser system on an integrated photonics chip.
